(19) United States
(12) Patent Application Publication
(10) Pub. No.: US 2011/0145325 A1
(43) Pub. Date: Jun. 16, 2011

(54) RUNNING AN INTERACTIVE MULTI-USER APPLICATION AT A MOBILE TERMINAL

(75) Inventor: Georg K. Hampel, New York, NY (US)

(73) Assignee: ALCATEL-LUCENT USA INC., Murray Hill, NJ (US)

(21) Appl. No.: 12/639,611

(22) Filed: Dec. 16, 2009

(51) Int. Cl. G06F 15/16; G06F 15/163

(52) U.S. Cl. 709/203; 709/208; 709/227

(57) ABSTRACT

A method of running an interactive multi-user application at a terminal of a communication system, according to which the terminal accesses a server of the communication system to create or update thereat, using a set of application-agnostic tools implemented at the server, a slave process corresponding to the interactive multi-user application. The terminal then communicates with the slave process to provide and receive state-vector updates corresponding to the application group running this interactive multi-user application. The state-vector updates are used by this terminal and each of the other terminals from the application group to concurrently calculate and track the global state of the application in a mutually consistent manner.

### CROSS-REFERENCE TO RELATED APPLICATIONS

The subject matter of this application is related to that of U.S. patent application Ser. No. ______, by K. Georg Hampel, attorney docket reference ALU 805848, filed on the same date as the present application, and entitled “SERVER PLATFORM TO SUPPORT INTERACTIVE MULTI-USER APPLICATIONS FOR MOBILE CLIENTS,” which is incorporated herein by reference in its entirety.

### BACKGROUND

1. Field of the Invention

The present invention relates to communication equipment and, more specifically but not exclusively, to network servers and terminals.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Real-time, multi-user applications, such as online multi-player games, distributed interactive simulations, whiteboarding, and screen-sharing, are becoming increasingly popular due to the continuing advances in the software and hardware used in end terminals and network servers. Interactive multi-user applications are typically implemented using either the peer-to-peer model or the client-server model. In the latter model, which is of particular interest to this specification, messages from the clients that specify their actions are processed at a dedicated server. For example, clients might contact the server to play a game with each other. The server calculates and keeps track of the global state of the game, processes messages received from the clients, changes the global state of the game based on the processing, and notifies the clients about the effects of their actions. The clients themselves do not send messages to one another, and the only communication in the system is between the server and clients.

One problem with the current client-server model is that the server software is usually highly application-specific. This property inhibits the development of new interactive multi-user applications, for example, because many application developers do not have the skills or resources to develop and integrate the needed server functionality. Even if appropriate server functionality is developed, the subsequent operation and support of the server might significantly increase the cost of the application and, therefore, detrimentally affect its competitiveness in the marketplace.

### SUMMARY

Disclosed herein are various embodiments of a method of running an interactive multi-user application at a terminal of a communication system, according to which the terminal accesses a server of the communication system to create or update thereat, using a set of application-agnostic tools implemented at the server, a slave process corresponding to the interactive multi-user application. The terminal then communicates with the slave process to provide and receive state-vector updates corresponding to the application group running this interactive multi-user application. The state-vector updates are used by this terminal and each of the other terminals from the application group to concurrently calculate and track the global state of the application in a mutually consistent manner.

According to one embodiment, at a terminal of a communication system, provided is a method of running an executable of a first interactive multi-user application having the steps of: (A) sending, to a server of the communication system, a request to establish or join, as a client, a first application group corresponding to the first interactive multi-user application; (B) providing, to the server, input to configure one or more application-agnostic tools implemented at the server to create or update at the server a slave process corresponding to the first application group; and (C) running the executable to calculate a global state of the first interactive multi-user application based on communications with the slave process.

According to another embodiment, provided is a terminal for a communication system having: (A) means for sending, to a server of the communication system, a request to establish or join, as a client, a first application group corresponding to a first interactive multi-user application; (B) means for providing, to the server, input to configure one or more application-agnostic tools implemented at the server to create or update at the server a slave process corresponding to the first application group; and (C) means for running an executable of the first interactive multi-user application to calculate a global state of the first interactive multi-user application based on communications with the slave process.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of a communication system in which various embodiments of the invention can be practiced;

FIG. 2 shows a method of managing application groups that can be used by a server of the communication system shown in FIG. 1 according to one embodiment of the invention;

FIG. 3 shows a method of executing a User-Access Protocol that can be used in the method of FIG. 2 according to one embodiment of the invention;

FIG. 4 shows a method of using third-party components during an interactive application session administered by a server of the communication system shown in FIG. 1 according to one embodiment of the invention;

FIG. 5 shows an exemplary processing sequence that can be executed at a mobile terminal of the communication system shown in FIG. 1 according to one embodiment of the invention;

FIG. 6 shows an exemplary processing sequence that can be executed at a mobile terminal of the communication system shown in FIG. 1 according to another embodiment of the invention; and

FIG. 7 shows a block-diagram of a server platform that can be used by a server of the communication system shown in FIG. 1 to support the processing sequence of FIG. 5 or FIG. 6 according to one embodiment of the invention.

### DETAILED DESCRIPTION

A major implicit assumption of a typical prior-art client-server platform for running an interactive multi-user application is that a mobile (e.g., wireless) terminal is process-lame and relatively low in battery power. In contrast, the server is believed to be ultra-speedy, with a substantially infinite processing capacity. While these assumptions might have been correct in the past, this is no longer the case today. More specifically, the processing power of high-end mobile terminals has been continually increasing and has reached a relatively high level. As a result, the processing required by many interactive multi-user applications can now be accommodated entirely by the mobile terminal itself. The speed of the application is no longer limited by the processing time, but rather, by the bandwidth and latency of the air interface. In addition, battery-power consumption is now mostly affected by the connection duration, which depends on the specific application and not on the manner in which the processing corresponding to the application is partitioned between the mobile terminal and application server.

Embodiments of the present invention capitalize on the above-specified changes in the hardware to provide a qualitatively different server platform for running interactive multi-user applications. More specifically, instead of being application-specific, as in the prior art, an application server of the invention is a generic or application-agnostic server, with its functionality being directly applicable to different/disparate interactive multi-user applications. The server manages inter-client interactions through a dedicated slave process, which is created by invoking and configuring a set of application-agnostic tools. By combining and customizing the application-agnostic tools in an appropriate manner, the server is capable of creating a suitable slave process for any compliant interactive multi-user application. The application-specific processing is removed from the server and, instead, is delegated to and performed by the mobile terminal(s).

As further detailed below, various embodiments of the disclosed server platform provide one or more of the following benefits and/or advantages over the existing client-server platforms: (1) the server platform is expected to spur development of new interactive multi-user applications because it enables application developers to focus on the application itself, without having to dedicate a significant effort to the development of the corresponding application server; (2) an investment into the server is no longer at risk of being completely lost in an unfortunate event of market failure of any particular application because the server software is no longer application specific; (3) due to the removal of application-specific functions from the server platform, the server's architecture, scalability, load balancing, and operation, administration, and maintenance (OAM) functions become less cumbersome and/or complex; (4) the server platform provides a usage-based revenue-generating opportunity because users can be charged in small incremental amounts for access to the server regardless of the particular application being used; and (5) the server platform substantially lowers the upfront investment into the application server because it can be grown based on the market demand, e.g., according to the popularity of the server platform with application developers.

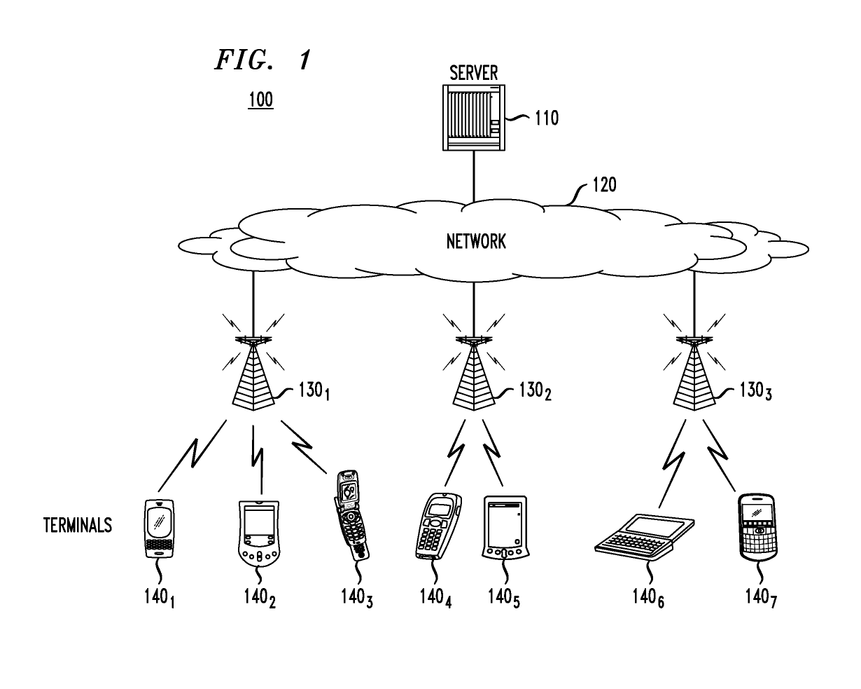

FIG. 1 shows a block diagram of a communication system 100 in which various embodiments of the invention can be practiced. System 100 has a server 110 connected to a network 120. Network 120 is a telecommunications network comprising a plurality of telecommunications links and nodes (not explicitly shown) arranged so that messages can be passed from one part of the network to another over one or more of the links and through one or more of the nodes. In various embodiments, network 120 might include one or more of a computer network, a cable network, a public switched-telephone network, a local-area network (LAN), a metropolitan-area network (MAN), a wide-area network (WAN), a virtual private network (VPN), and the Internet.

System 100 further has a plurality of base stations 130 connected to network 120. Different base stations 130 provide wireless links for mobile terminals 140 and might belong to the same or different service providers. In various embodiments, base stations 130 and mobile terminals 140 might support and use different types of access technology, such as EDGE, CDMA, UMTS, LTE, WiFi, and WiMAX.

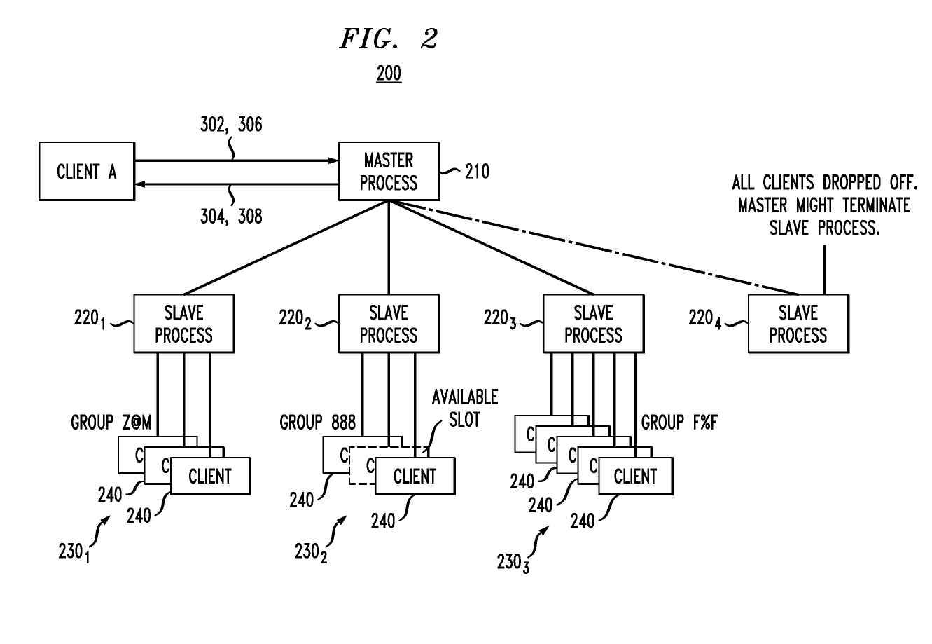

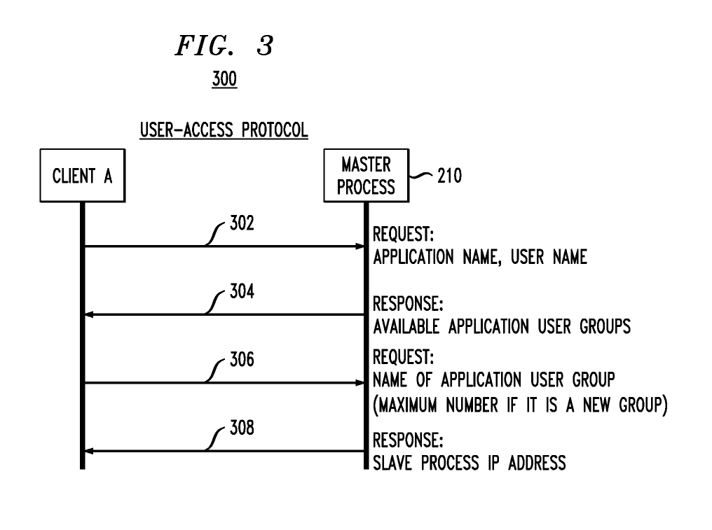

Server 110 is a generic (non-specific, application-agnostic) application server designed to support a plurality of different compliant interactive multi-user applications. As already indicated above, server 110 does not handle any substantial amount of application-specific processing, which is delegated to and resides in mobile terminals 140. Rather, server 110 is configured to perform one or more of the following functions: (i) application-group management, (ii) application-runtime management, (iii) persistent-data management, (iv) policy management, and (v) network-load management. These functions are described in more detail below in continued reference to FIG. 1 and, where appropriate, also in reference to FIGS. 2-3.

In various embodiments, server 110 can be realized as an actual physical machine connected to network 120 or a virtual machine that is part of the network. Various client-server protocols used in system 100 can be Hypertext Transfer Protocol (HTTP)-based and use any suitable scripting language. Server 110 supports push-mes sage mechanisms, in which updates are actively transferred (pushed) to the corresponding mobile terminals 140 as soon as these updates become available.

### Application-Group Management

FIG. 2 shows a method 200 of managing application groups that can be used by server 110 according to one embodiment of the invention. Every interactive multi-user application associated with a certain group of clients 240 is referred to as an “application group.” Illustratively, three different active application groups 230₁-230₃ are shown in FIG. 2. Different application groups 230 might correspond to the same or different interactive multi-user applications. Each client member 240 of an application group 230 resides, e.g., in one of mobile terminals 140 (FIG. 1). Each particular mobile terminal 140 can be a host to one or more clients 240. Different clients residing in the same mobile terminal 140 might correspond to different application groups 230.

When an application group 230 is active, its member clients 240 interact with each other through a corresponding dedicated slave process 220, which is run by server 110. Clients 240 belonging to one application group (e.g., application group 230₁) do not normally interact with clients 240 belonging to a different application group (e.g., application group 230₃). Each slave process 220 can be implemented as a separate thread, a dedicated process (e.g., a running instance of a program characterized by the corresponding data and state variables), or a dedicated virtual machine.

Server 110 runs a master process 210 that controls different slave processes 220. Master process 210 supports at least the following functions: (i) creating a new slave process, (ii) terminating an existing slave process, and (ii) assigning new clients to existing slave processes and application groups. Note that (common, single) master process 210 controls multiple slave processes 220. Neither master process 210 nor slave process 220 contains a running executable of the pertinent application(s).

In one embodiment, master process 210 manages slave processes 220 and application groups 230 based on a master table maintained in the memory of server 110. Table 1 provides an exemplary format of such a master table.

TABLE 1
Master Table for Master Process 210

| Slave- | | Application- | Minimum | Maximum | Actual | Application- |
|---|---|---|---|---|---|---|
| Process | Application | Group | Number | Number | Number | Group |
| Index | Name | Name | of Clients | of Clients | Clients | Status |
| 1 | App A | Group Z@M | 2 | 3 | 3 | Closed |
| 2 | App A | Group 888 | 2 | 3 | 2 | Open |
| 3 | App B | Group F%F | 5 | 5 | 5 | Closed |
| 4 | App C | Group FOO | 2 | 100 | 0 | Open |

The master table is updated as necessary, e.g., when (i) a new user/client creates a new application group or joins an existing application group or (ii) an existing client departs from the corresponding application group.

Referring to FIG. 2 and Table 1, application groups 230₁ (named Group Z@M) and 230₂ (named Group 888) run two separate instances of the same interactive multi-user application (App A). Application group 230₁ has three clients 240, which is the maximum allowed number of participants for App A. As a result, application group 230₁ does not accept new clients, which is reflected in the “closed” status of that application group. In contrast, application group 230₂ has only two clients 240 and is able to accept one additional client, which is reflected in the “open” status of that application group. Application group 230₃ is similar to application group 230₁ in that it has the maximum allowed number of clients, which is five for App B. As such, application group 230₃ is “closed” to new participants. Application group 230₄ is empty and open to new clients. Application group 230₄ can be empty, e.g., because all previously registered clients have signed off. Master process 210 will terminate slave process 220₄ if no new clients sign in within a predetermined period of time.

Although master process 210 controls the creation/termination of each slave process 220ᵢ and the admission of clients to the corresponding application group 230ᵢ, actions of the master process are driven by requests from the clients. More specifically, server 110 and mobile terminal 140 employ a client-server protocol, which is referred to as the “User-Access Protocol.” The User-Access Protocol is activated by client 240 as soon as an executable of a compliant application is started at the corresponding mobile terminal 140. After being activated, the User-Access Protocol enables appropriate client-server interactions. In one configuration, the IP address or URL of master process 210 is pre-programmed in the application, e.g., in the form of a configuration file. Alternatively, the IP address or URL of master process 210 can be specified by the user when the application software is installed or started at the corresponding mobile terminal 140.

FIG. 3 shows a method 300 of executing the User-Access Protocol that can be used in method 200 according to one embodiment of the invention. Illustratively, certain aspects of method 300 are described in reference to Client A, which is shown in the top left corner of FIG. 2. Client A can reside, e.g., in a mobile terminal 140 (FIG. 1). The vertical lines extending down from Client A and master process 210 in FIG. 3 represent increasing time. Each of the horizontal arrows that connect the two time lines represents a respective one of handshake messages 302-308 exchanged by Client A and master process 210 in the process of executing the User-Access Protocol.

Message 302 from Client A to master process 210 contains the application and user names. The application name is usually provided as an integral part of the application itself. The user name is usually specified by the user when the user installs or starts up an executable of the application on mobile terminal 140. If the user name is not specified or not required by the application, it can be replaced, e.g., by a random number.

After message 302 is received, master process 210 consults a master table (e.g., Table 1) to identify slave processes 220 corresponding to the application name contained in the message. Based on the contents of the master table, master process 210 sends message 304 back to Client A with the following options: (1) create a new application group and (2) join one of the existing “open” application groups running the specified application. For example, let us suppose that message 302 from Client A specifies App A. Then, in the second option of message 304, master process 210 offers Client A to join Group 888 (see Table 1). In one implementation, a list of possibilities corresponding to the second option of message 304 might include additional information from the master table, such as the current number of users in each eligible application group and user names.

In response to message 304 and based on the information contained in that message, Client A sends message 306, in which it specifies the name of the application group it wishes to join. For example, if the user wishes to create a new application group, then message 306 contains the name for the new application group and, optionally, the minimum and/or maximum number of users that can join the group. Note that, for some applications, the maximum/minimum number of users might be an inherent characteristic of the application itself (for example, the game of chess requires exactly two players). Alternatively, if the user wishes to join an existing application group 230, then message 306 contains a name selected by the user from the list of possibilities contained in message 304.

In response to message 306, master process 210 sends message 308, in which it provides the IP address of slave process 220 corresponding to the selected application group. More specifically, if message 306 contains a new application-group name, then master process 210 creates a corresponding new slave process 220, assigns Client A to that new slave process, specifies the IP address of the slave process in message 308, and updates the master table. Alternatively, if message 306 refers to an existing application group, then master process 210 assigns Client A to that group, specifies the IP address of the corresponding slave process 220, and updates the master table. If the number of users in the assigned application group has reached the maximum number after the admission of the new user, then the application-group status in the master table is changed from “open” to “closed.”

In various embodiments, the above-described User-Access Protocol can be modified as appropriate or necessary. For example, master process 210 can be configured to ask the implicated slave process 220 for permission to add a new user. In response to such a request from master process 210, the implicated slave process 220 might poll all members of the corresponding application group 230 for any possible objections and then communicate the poll results back to the master process. Alternatively, one particular user of the implicated application group might be declared “group leader” empowered to make admission decisions on behalf of the group. For example, the user that created the application group can be the group leader. Different conditional variations of the admission policy can be invoked by message 302, e.g., by referring to the corresponding policy option.

If the number of users that have joined a new application group is below the minimum number, then master process 210 might delay starting the corresponding slave process until the minimum number is reached. In this particular situation, method 300 might include one or more additional messages transmitted between Client A and master process 210, e.g., during the time interval between messages 306 and 308.

### Application Runtime Management (ARM)

The ARM function of server 110 provides a shell-like program for each slave process 220. As used herein, the term “shell” refers to a piece of software that provides an interface between clients/users and various services of the server. A primary function of the shell is to invoke or launch another piece of software, which is selected and configured by the shell based on the received input(s). A shell-like program of the server works similar to a conventional shell, except that the inputs that drive/configure the shell-like program are provided through the Application Runtime Protocol (ARP)-language interface and are generated by the application executable(s) running on the client terminal(s) of the corresponding application group.

The ARM function of server 110 is capable of providing respective shell-like programs for slave processes 220 corresponding to different applications. For each particular slave process 220ᵢ, the ARM function requires all clients 240 from the corresponding application group 230ᵢ to obey a specified set of rules and behave in a manner that is consistent with the rules. This requirement does not mean that all clients have to run the same application software, for example, because the application software might depend on the operating system of mobile terminal 140. Furthermore, different clients 240 belonging to the same application group 230 might run different versions of the corresponding application. However, as long as each client 240 belonging to a particular application group 230 behaves with respect to the corresponding slave process 220 in a manner that is consistent with the corresponding set of rules and independent of the application version and/or operating system running on host mobile terminal 140, the ARM function of server 110 is able to provide a properly functioning shell-like program for the slave process.

Compatibility of different applications with the ARM function of server 110 can be enforced, e.g., by making the rule sets available to application developers and then monitoring compliance through the policy-management function of the server (see below). More specifically, application developers take appropriate measures to ensure proper version control so that mutually incompatible versions of an application are treated by server 110 as different applications, thereby barring the corresponding users from joining the same application group. Appropriate policy-management measures are implemented to ensure that (i) the corresponding ARM rule set is specified for each application, (ii) application names are registered and recognizable by server 110, and (iii) the clients running each particular application are able to access and use the server.

In one embodiment, the ARM function of server 110 provides access to a set of configurable application-agnostic tools. Representative examples of such tools are listed in Table 2.

TABLE 2
Application-Agnostic Tools of the ARM Function

| Tool | Brief Description |
|---|---|
| Maintaining a table of clients | The table might list the current |
| for a slave process | application-runtime states for different |
| | clients (see also the ARP protocol below) |
| Maintaining and providing | Exemplary parameters: the number of |
| access to a specified | clients in an application group and the |
| set of parameters | corresponding user names |
| Dynamically creating and/or | Exemplary fields of a state-vector entry: |
| updating a state vector | (i) Name; (ii) Type, e.g., integer, float, |
| | char, string, array, bitmap; (iii) Data; (iv) |
| | Attribute, e.g., “user name” or “global”; |
| | (v) Timestamp, e.g., the time of the last |
| | update of the entry |
| Providing access to a library of | Exemplary functions: (i) conditional |
| functions that operate on state | expressions; (ii) sort/select functions, e.g., |
| vectors and/or specified | enabling selection of state-vector entries |
| parameters | having a specified characteristic, such as |
| | “Name” or “Data” that satisfies a |
| | specified conditional expression; (iii) |
| | standard arithmetic functions, including |
| | vector functions; (iv) random number; (v) |
| | clock |
| Dynamically creating and/or | Enables clients to define macros. An |
| updating a composite | exemplary composite function: select all |
| function based on standard | users that are located within a specified |
| (e.g., library) functions | geographical area, e.g., having a latitude |
| and/or custom functions | and longitude that differ from my latitude |
| defined by the clients | and longitude by respective specified |
| | amounts |
| Supporting an Application | The ARP protocol enables clients to |
| Runtime Protocol (ARP) | interact with the corresponding slave |
| | process. The ARP protocol can be |
| | analogized to a conventional client-server |
| | protocol, wherein the server is substituted |
| | by the slave process. The ARP protocol |
| | supports three operating modes (startup, |
| | steady-state, and power-down) and is |
| | implemented using request/response |
| | message pairs, with the requests being |
| | initiated by the client |
| Supporting a push-message | Enables the slave process to proactively |
| mechanism | push messages to a corresponding client. |

The following is exemplary pseudocode for a state-vector entry:

<state>

<name> ParameterName </name>
<type> float </type>
<attribute> global </attribute>
<value> 453.234 </value>

</state>

In this particular example, a global variable named ParameterName is assigned a value of 453.234.

The following is exemplary pseudocode for a recursive-function declaration:

<func>

<name> LatitudeWindow </name>
<type> vector </type>
<minus>

<stateVector> latitude </ stateVector >

<makeVector>

<stateVector>

<index> userName </index>

</stateVector >

</makeVector>

</minus>

</func>

In this particular example, “latitude” is a predefined state vector containing the latitudes of all clients 240 belonging to a particular application group 230. <makeVector>, <minus>, and <index> are library functions and/or functions defined by the clients. The declared LatitudeWindow operation takes the vector composed of latitude values of all the clients and subtracts from each component of this vector the latitude of the client corresponding to user “userName.”

The startup mode of the ARP protocol can be initiated by Client A as soon as it is admitted to an application group. In the startup mode, Client A can define dynamic state-vector entries and dynamically configurable functions. Client A can also load persistent data into dynamic state-vector entries. Specific operations that can be performed during the startup mode are usually programmed into the application. The corresponding slave process 220 checks the newly defined states and functions for uniqueness. Duplicate states and functions are discarded; the new ones are added to the corresponding list maintained by slave process 220. Every request made by the client is processed and confirmed or denied by slave process 220.

If the number of clients in a particular application group has not yet reached the minimum number required by the application, then each client of that application group remains in the startup mode. In one configuration, slave process 220 does not allocate memory to its clients while being in the startup mode. In the initial ARP handshake, a client might specify how it wishes to be informed when the required minimum number of clients is reached. For example, the client might specify that it will check the number of clients by periodically sending an appropriate inquiry to slave process 220. Alternatively, client 240 might specify that it expects slave process 220 to use a push-message mechanism to provide a notification.

Client 240 enters the steady-state mode after all appropriate startup-mode procedures/operations have been completed. While in the steady-state mode, the user (through client 240) participates in the corresponding interactive multi-user application. More specifically, the ARP protocol enables client 240 to update and retrieve state-vector entries corresponding to slave process 220. The ARP protocol further enables client 240 to embed predefined or dynamically configurable functions in its request messages directed to slave process 220. This feature of the ARP protocol helps to make the client/slave-process interaction much more efficient because it provides means for calling the functions defined during the startup mode without having to define them in a request message. The ARP protocol also enables one client to push information (e.g., via a push-message mechanism, see below) to other clients of its application group. Note that various actions performed by slave process 220 are initiated by the clients through ARP request messages, each of which triggers a corresponding action of the slave process.

The power-down mode enables a client to gracefully depart from the corresponding application group 230. A transition to this mode is usually initiated by the user through an interactive feature, which is part of the application. In power-down mode, using the ARP protocol, client 240 informs the corresponding slave process 220 about the user's departure. In response, slave process 220 updates its user table and sends a corresponding update to master process 210. Based on this update, master process 210 updates the master table (see Table 1).

The push-message mechanism is used because, in a wireless network, an air-link is usually torn down after a short period (e.g., a few seconds) of inactivity. The push-message mechanism can be based, e.g., on a paging mechanism of the wireless network, which is usually associated with additional infrastructure and air-interface costs. Therefore, the use of the push-message mechanism might result in additional charges to the user. The push-message mechanism can be supported by network 120 through Wireless Application Protocol (WAP) Push and/or binary Short Message Service (SMS). The ARP setup mode can be used to select and specify a particular type of air-interface technology to be used by slave process 220 for push messaging.

### Persistent-Data Management

Persistent-data management (PDM) is a feature that enables users to permanently save data, such as gaming scores and/or reusable information gathered during an interactive session, on server 110. In one embodiment, access to persistent data is enabled by “write” and “read” operations embedded into the ARP protocol. The access can therefore be exercised, e.g., using the steady-state mode of the ARP protocol. The write and read operations are normally applied to a set of state-vector entries, thereby causing the content of these entries to be written into a permanent (non-volatile) memory of server 110. Alternatively or in addition, the PDM function can be exercised during the startup and power-down modes. Clients 240 can mine the persistent data corresponding to their application group, e.g., by sending an appropriate request to the corresponding slave process 220.

In one embodiment, server 110 supports a data-transfer protocol that enables retrieval of persistent data even after the corresponding slave process 220 is terminated (i.e., not exclusively during a runtime of the application). To access the persistent data without entering an interactive runtime session, the user configures its mobile terminal 140 to start the data-transfer protocol. After appropriate authentication and authorization, the data-transfer protocol enables the user to access and retrieve the pertinent persistent data from server 110.

### Policy Management

The policy-management function of server 110 enables (i) user authentication and authorization, (ii) application authentication and authorization, (iii) billing, and (iv) miscellaneous auxiliary functions.

User authorization and application authorization are separate procedures. During each of these procedures, a respective shared key can be arranged and used for authentication and authorization. Both procedures can be performed as part of and/or embedded into the User-Access Protocol. Standard transport-layer security mechanisms can be used to implement these procedures.

The billing function is applied to users and/or application providers. A user can be billed based on the actual interactive airtime (e.g., duration of the steady-state mode) and/or specific features used (e.g., push messages). Billing rates can be explained and agreed to, e.g., during the startup mode. An application provider can be billed, e.g., based on the number of unique users of the application registered by server 110.

Auxiliary functions include, but are not limited to conventional operations and maintenance functions.

### Network-Load Management

The network-load management function of server 110 is an optional function that supports: (i) traffic monitoring, per service provider and/or per cell, and (ii) restricting traffic loads based on specified traffic-threshold levels. Traffic monitoring per cell can be accomplished, e.g., by configuring each host mobile terminal 140 to provide a cell identifier (e.g., the IP address of the corresponding base station 130). Traffic-load restrictions might be used, e.g., to ensure that the paging capacity of the air interface is not exceeded to enable push messages to go through.

### Incorporation of Third-Party Components

Server 110 is optionally configurable to enable interactive multi-user applications to incorporate third-party components, such as maps and other graphic elements (e.g., avatars), into interactions between clients. A client can import a user-centric component directly from a third-party server or website and then dynamically update its parameters during the runtime of the application. Server 110 enables different clients 240 to communicate these updates to each other.

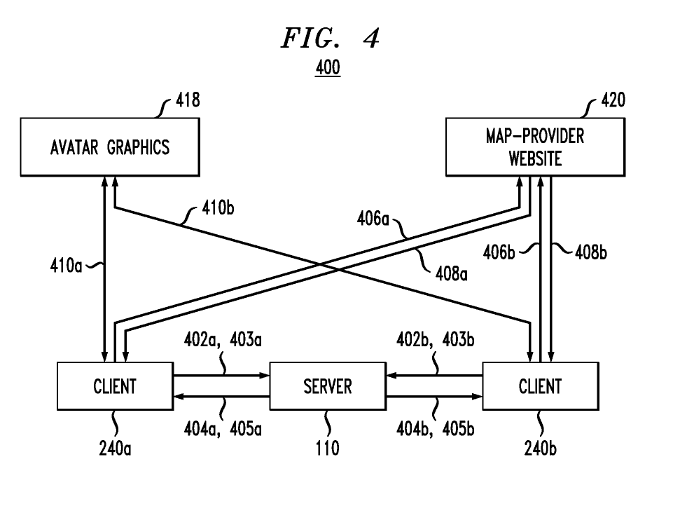

FIG. 4 shows a method 400 of using third-party components during an interactive application session administered by server 110 according to one embodiment of the invention. For illustration purposes, method 400 is described in reference to (i) two specific third-party components, i.e., geo-location mapping and avatar animation, and (ii) two clients 240a-b. One skilled in the art will understand that method 400 can be modified in a relatively straightforward manner to handle (i) a different number of third-party components, which are not necessarily limited to geo-location mapping and avatar animation, and (ii) a different number of clients 240.

Dynamic geo-location mapping of multiple clients in method 400 relies on (i) GPS sensors of mobile terminals 140 hosting the clients to determine their respective geo-locations and (ii) a website or server 420 operated by a map provider to graphically render the determined geo-locations. Each of clients 240a-b discloses the geo-location information obtained from the GPS sensor(s) of its host terminal by sending a respective message 402 to server 110. Based on messages 402a-b, server 110 creates and/or updates the corresponding state-vector entries and then sends, via messages 404a-b, an appropriate state-vector update back to clients 240a-b, respectively.

Using geo-location entries of the state vector, client 240 compiles and sends a request 406 to website 420 specifying the scale, size, and type of a desired map. After the map is generated by website 420, client 240 receives the map from the website via a data transmission 408, uses the geo-location information to mark on the received map the positions of clients 240a-b, and displays the resulting map to the user. Note that not each state-vector update causes client 240 to send request 406. For example, client 240 can reuse a previously received map provided that the updated geo-location coordinates of the participating clients remain within the boundaries of that map.

Avatar animation in method 400 relies on conventional avatar-puppeteering methods to decompose a compound movement of the avatar into constituent movements of individual joints of the avatar's skeleton (see, e.g., http://www.avatarpuppeteering.com). Note that clients 240a-b are not required to use the same skeleton type. Rather, each client can use a different respective skeleton type, provided that appropriate vector-graphic support is available for the skeleton from an avatar-graphics server 418 (see also http://www.opengl.org). For example, during the above-described setup mode, each client can create or select, using a communication link 410, a respective avatar on server 418. Clients 240a-b then exchange the avatar information via server 110. More specifically, client 240 sends a message 403 with its avatar information to server 110. After server 110 receives avatar information from the clients, it compiles and sends messages 405a-b to disseminate that information. In one embodiment, the avatar information of message 405 contains the corresponding vector graphics in an explicit form. In an alternative embodiment, message 405 contains a pointer link to server 418, which enables client 240a,b to download, via communication link 410, the corresponding vector graphics.

During the steady-state mode, server 110 mediates the transmission of information about the motion of avatar skeletons between clients 240a-b, e.g., using appropriate entries of the state vector. The amount of data that needs to be transmitted to describe this motion is relatively small because the vector graphics representing the avatars have already been preloaded to each of clients 240a-b, e.g., as described above. Using the preloaded vector graphics and avatar entries of the state vector, each of clients 240a-b is able to render the moving avatars and display them to the corresponding user during the interactive session. Note that all processing associated with the rendering is performed by client 240a.b itself, with server 110 only channeling the data that define the configuration of the avatars' skeletons.

### Examples of Interactive Multi-User Applications

Two interactive multi-user applications described in this subsection are designed to operate using an application-agnostic server similar to server 110 so that substantially all application-specific processing is handled by mobile terminals. The first example is “Chess,” which can be viewed as a representative interactive board game. The second example is “First-Person Shooter,” which illustrates how synchronization issues can be addressed according to various embodiments of the invention. For illustration purposes, both examples are described in reference to FIGS. 1-2.

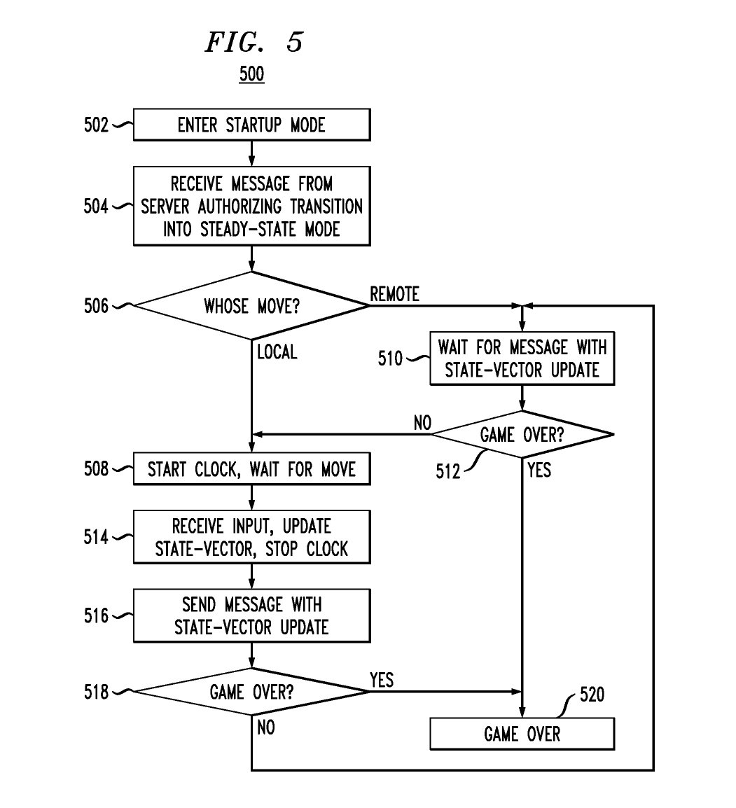

FIG. 5 shows an exemplary processing sequence 500 that can be executed at mobile terminal 140 configured to play Chess according to one embodiment of the invention. At step 502 of processing sequence 500, terminal 140 enters the startup mode and sends a request to server 110 indicating that the user of terminal 140 wishes to play Chess. In response, master process 210 running on server 110 starts a corresponding slave process 220. Since Chess requires exactly two players, the minimum and maximum number of clients in the corresponding entry of the master table (see Table 1) is two. Server 110 and mobile terminal 140 remain in the startup mode until a second player joins the Chess application group.

At step 504, mobile terminal 140 receives a message from server 110 indicating that a second player has joined the Chess application group. Server 110 and mobile terminal 140 therefore leave the startup mode and enter the steady-state mode. The status of the Chess application group in the master table (see Table 1) is now set to “closed,” and no additional players can join this application group.

At step 506, mobile terminal 140 determines whose turn it is to move in the game. If it is the local player's turn, then mobile terminal 140 directs the processing of method 500 to step 508, where it starts the clock corresponding to the local player and waits for the next move to be entered. If it is the remote player's turn, then mobile terminal 140 directs the processing to step 510, where mobile terminal 140 requests and waits for a message from server 110 with a state-vector update containing the next move of the remote player. When the message is received, mobile terminal 140 notifies the local player about the move and directs the processing to step 512, where it evaluates the status of the game. For example, if the last move resulted in a checkmate, then the game is over and terminated at step 520. If the game is not over, then the processing is directed to step 508.

At step 514, which follows step 508, mobile terminal 140 receives an input from the local player indicating the next move. Mobile terminal 140 then evaluates the move to check whether it is compliant with the rules of the game. If the move is illegal, then it is rejected, the local player is warned, and mobile terminal 140 continues to wait for the next (legal) move. If the move is legal, then it is accepted. Mobile terminal 140 then displays the resulting configuration of the chess pieces on the screen, updates the state vector, and stops the clock corresponding to the local player.

At step 516, mobile terminal 140 of the local player sends a message to server 110 with a state-vector update corresponding to the move accepted at step 514. Upon receipt of this message, server 110 sends a push message to mobile terminal 140 of the remote player indicating that a state-vector update is now available.

At step 518, mobile terminal 140 evaluates the status of the game. If the game is not over, then mobile terminal 140 directs the processing back to step 510. If the game is over, then the processing is directed to step 520, where the game is terminated.

Note that, in method 500, all processing specific to the game of chess (e.g., running the player-specific clock, evaluating the legality of moves, evaluating the game status, and graphically rendering the configuration of chess pieces) is performed by mobile terminals 140. In contrast, the tasks performed by server 110 are fully supported by application-agnostic tools. For example, server 110 sets up an application group for the players, authorizes transitions between various ARP modes, and facilitates exchanges carrying state-vector updates. Server 110 might also be configured to save every move in a persistent memory so that the log of the game is retrievable at a later time and, eventually, from a different authorized terminal.

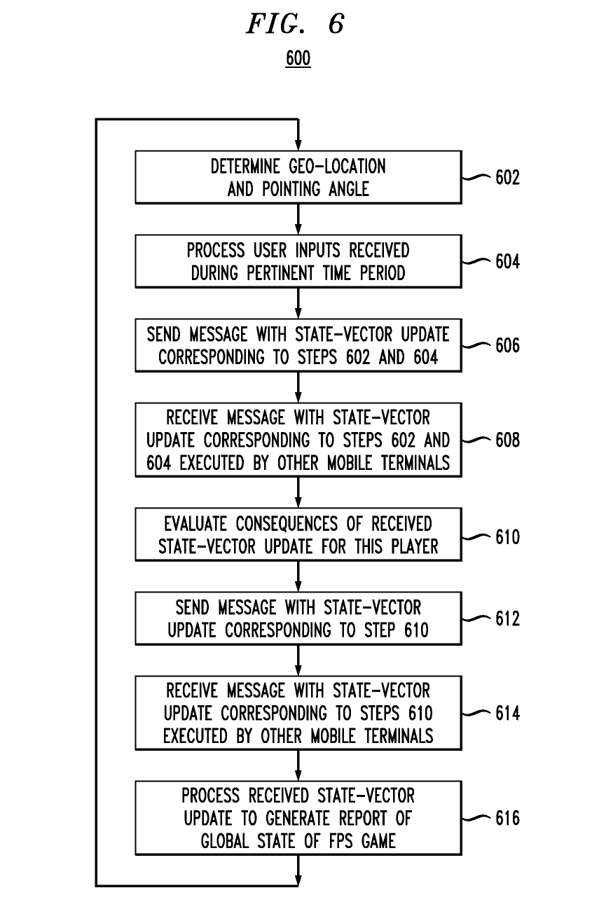

FIG. 6 shows an exemplary processing sequence 600 that can be executed at mobile terminal 140 configured to play a First-Person Shooter (FPS) game according to one embodiment of the invention. An FPS game requires at least two players, but does not have an upper limit to the number of players. Therefore, the startup mode does not terminate until a second player has joined the FPS application group. However, the group's status remains “open” to enable new players to join the group even after the FPS application group has transitioned to the steady-state mode. Server 110 can maintain the open status for the group, e.g., by specifying a very large value in the “maximum-number” field of the master table (see Table 1).

To be able to participate in an FPS game, a mobile terminal 140 needs to have a GPS sensor and a compass for measuring the terminal's pointing angle. These sensors enable the player to point and fire a “gun” and the application software to trace the trajectory of the “bullet.” Another player is deemed to be hit by the bullet when (i) the geo-location of that player is closer to the shooter than a specified maximum shot length and (ii) the direction of the shot lies within a specified angular sector centered on the imaginary line of site connecting the two players. In some variants of the game, a player can protect himself from being hit by holding up an appropriately oriented “shield.” The player cannot shoot with the shield up. Points are awarded for hitting other players and subtracted for using the shield and missing when shooting.

Processing sequence 600 is similar to processing sequence 500 in that, in the steady-state mode, sequence 600 causes each mobile terminal 140 to execute a cyclic sequence of tasks defined by the underlying application. However, to keep track of the motion and shooting (which take place on a relatively short time scale), processing sequence 600 is repeated much more frequently than processing sequence 500. As a result, different mobile terminals 140 are forced to execute all necessary application-specific processing substantially concurrently and in parallel to one another. Yet, processing sequence 600 enables all participating mobile terminals 140 to achieve results that are consistent across the entire FPS application group.

At step 602 of processing sequence 600, mobile terminal 140 determines its geo-location and pointing angle. The geo-location can be obtained, e.g., by reading it off the terminal's GPS sensor. Similarly, the pointing angle can be obtained, e.g., by reading it off the terminal's compass.

At step 604, mobile terminal 140 processes the user inputs that have been received in the time period since the previous instance of step 604 (i.e., step 604 of the previous loop of method 600). If this particular instance of step 604 is the very first instance of this step after the commencement of the steady-state mode, then mobile terminal 140 processes the user inputs that have been received thus far. The user inputs might indicate a change in the shield setting (e.g., to up or down), a shot-trigger action, etc. The processing might include barring illegal actions, e.g., by displaying a warning when the user attempts to fire a shot with the shield in the up position.

At step 606, mobile terminal 140 sends to server 110 a message with a state-vector update corresponding to steps 602 and 604. This state-vector update might describe a change in the geo-location and/or pointing angle detected at step 602, a change in the shield position effected at step 604, and/or parameters of a fired shot.

At step 608, mobile terminal 140 receives from server 110 a message with a state-vector update corresponding to steps 602 and 604 executed by mobile terminals 140 corresponding to other players. To reduce the air-interface traffic load, the received state-vector update might be filtered by server 110 to contain data corresponding only to participating mobile terminals 140 located within the maximum possible shot length from this particular mobile terminal. Server 110 can perform such filtering, e.g., using an appropriate filter-function defined for the server by the FPS client(s) during the startup mode.

At step 610, mobile terminal 140 evaluates the consequences of the received state-vector update for this particular player. For example, it might be determined that this player got hit by one or more other players. Alternatively or in addition, it might be determined that this player hit one or more other players. Shield positions are taken into account to determine the effect of the hits.

At step 612, mobile terminal 140 sends to server 110 a message with a state-vector update corresponding to step 610.

At step 614, mobile terminal 140 receives from server 110 a message with a state-vector update corresponding to step 610 executed by at least one mobile terminal 140 corresponding to another player.

At step 616, mobile terminal 140 processes the received state-vector update to calculate a global state of the game, which might include reward and/or penalty points, running scores for different players, and graphical representations in GUI. The processing of method 600 is then directed back to step 602.

Conceptually, steps 612-616 are synchronization and conflict-resolution steps that enable different clients in the FPS application group to consistently arrive at the identical global states of the game. These steps are performed because different mobile terminals 140 typically submit their respective state-vector updates to server 110 at different times. It is relatively difficult to synchronize the update submissions, e.g., because the delays on the wireless links might be different for different clients. Also, a mobile terminal might be temporarily blacked out because it has moved into a wireless-coverage hole.

The above-indicated time-jitter problems are addressed by configuring each mobile terminal 140 to time-stamp its state-vector updates submitted to server 110 (e.g., during steps 606 and 612). Server 110 is similarly configured to time-stamp each message containing state-vector updates (e.g., during steps 608 and 614). At step 616, mobile terminal 140 uses these time stamps and a set of conflict-resolution rules encoded by the developer in the FPS software to process the received state-vector updates in a manner that addresses the time-jitter problems. Since different mobile terminals 140 corresponding to the FPS application group run mutually consistent versions of the FPS software, they will consistently arrive at the identical global states of the game despite the absence of a central application-specific processing authority used in prior-art application servers.

While steps 612-616 are shown in FIG. 6 as separate steps, in an alternative embodiment, they can be merged with steps 606-610, respectively. More specifically, step 612 can be merged with step 606 of the next loop of method 600; step 614 can be merged with step 608 of said next loop; and step 616 can be merged with step 610 of said next loop.

Processing sequence 600 is similar to processing sequence 500 in that substantially all processing specific to the game (e.g., determination of the geo-location and pointing angle, changing the shield setting, firing shots, barring illegal actions, evaluating the global state of the game, and keeping the running scores for the players) is performed by mobile terminals 140. In contrast, the tasks performed by server 110 are fully supported by application-agnostic tools. For example, server 110 facilitates exchanges carrying state-vector updates and provides a common time baseline for mobile terminals 140 by time-stamping the corresponding messages.

In general, interactive multi-user applications for mobile terminals are constrained by the limited battery life and the air-interface usage. The air-interface usage is partitioned between data traffic and uplink- and downlink-access traffic. The downlink-access traffic, which carries push messages, is usually more expensive than the uplink-access traffic, which carries regular (non-push) messages. The battery power is primarily consumed by the transmit power amplifier and depends on the condition of the wireless link. To a lesser degree, the battery power is consumed by the GPS and processor chips.

A wireless network is usually configured to tear down a wireless connection after a few seconds of inactivity. This characteristic requires the downlink- and uplink-access mechanisms to eventually or periodically reestablish the wireless channel, which adds delay and reduces the responsiveness of the mobile terminals running the corresponding real-time interactive application. However, the tear-down saves battery power because the wireless link does not have to be sustained when there is no payload-traffic activity.

All these considerations indicate that some sort of tradeoff between the resource consumption and achievable performance characteristics might be advisable. When inter-client interactions are managed by an application-agnostic server, such as server 110, the tradeoff parameters can be selected and controlled by the client. This attribute of various embodiments of the invention can be used to gain advantages over the prior art because the client resides in the corresponding mobile terminal and, as such, “knows” best (e.g., better than the server) which configuration of this particular mobile terminal might be most beneficial. In contrast, in a typical prior-art scheme, the application server (not the mobile terminals) is empowered to select and control any possible tradeoffs, even though it is not well positioned to judge what works best for each individual mobile terminal.

Now turning to the above-described examples, we first note that a chess game can last for many hours. It is therefore beneficial to maintain the battery-discharge rate associated with the game at a relatively low level. We also note that slight time delays in handing over the game-specific processing from one mobile terminal to the other are not that important to the user entertainment value as long as the fairness of the clock is not detrimentally affected. Furthermore, the number of moves per game is typically relatively small, e.g., around fifty. In these circumstances, it is advantageous for the wireless link to be up only when a player makes a move. Waking up the other player is therefore best handled via a push-message mechanism. One skilled in the art will appreciate that a corresponding embodiment of the invention (e.g., method 500) makes it relatively straightforward to configure mobile terminal 140 in the above-described manner, thereby striking a tradeoff that is most beneficial to Chess.

The FPS game is very different from Chess because time delays can be very detrimental to the processing flow and to the player-entertainment value. Therefore, it is beneficial to minimize the number and/or frequency of wireless-link tear-downs, e.g., by configuring mobile terminal 140 to send relatively frequent client-server requests. The effect of these requests is that the wireless link is not torn down, which minimizes delays associated with wireless-link setup procedures. The downside, however, is a relatively high battery-discharge rate associated with the game. Yet, minimizing the delays is more important to the processing flow and player-entertainment value than the battery-discharge rate. Although the desired tradeoff for FPS is different from that for Chess, once again, a corresponding embodiment of the invention (e.g., method 600) makes it relatively straightforward to appropriately configure mobile terminal 140 and to strike a tradeoff that is most beneficial to FPS.

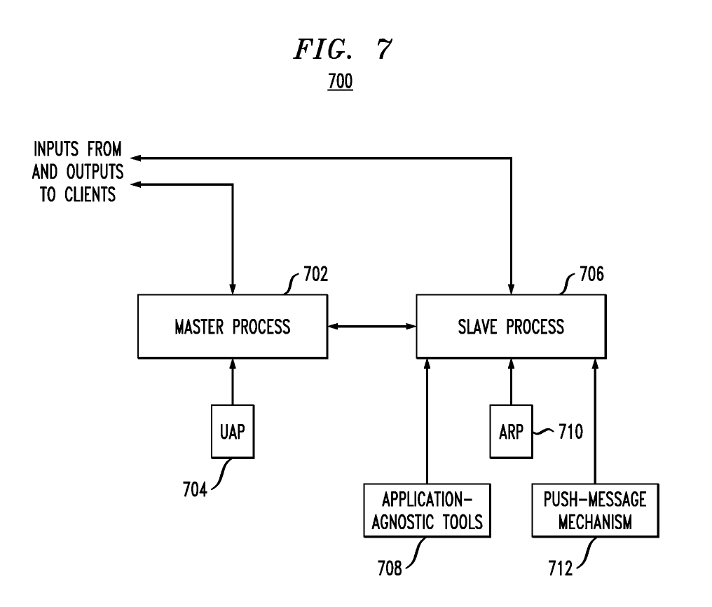

FIG. 7 shows a block-diagram of a server platform 700 that can be used by an application-agnostic server (e.g., server 110 of FIG. 1) to support processing sequence 500 or 600 according to one embodiment of the invention. The server runs a master process 702 to control a slave process 706. The server supports a User-Access Protocol (UAP) 704, which enables a new client to interact with master process 702. For example, the new client can select and join an application group corresponding to slave process 706. This application group might be an application group running Chess or FPS (see FIGS. 5 and 6). If slave process 706 does not yet exist when the new client first contacts the server, then User-Access Protocol 704 enables the client to establish a new application group. After such new application group is established, master process 702 creates slave process 706.

To create slave process 706, the server invokes a set 708 of application-agnostic tools. Such tools might include, but are not limited to processes that (i) maintain and provide access to a specified set of parameters, (ii) dynamically create and/or update a state vector for the application in question, (iii) provide access to a library of functions that operate on the state vector and/or the specified set of parameters, and (iv) dynamically create and/or update macros based on the functions from the library and the functions defined by the clients The server supports an Application Runtime Protocol (ARP) 710, which enables interactions between slave process 706 and the client members of the corresponding application group. The server also supports a push-message mechanism 712, which can be used to facilitate transmission of state-vector updates between slave process 706 and the clients. Additional description pertinent to set 708, Application Runtime Protocol 710, and push-message mechanism 712 can be found above, e.g., in Table 2 and the corresponding text.

Slave process 706 enables the client members of the corresponding application group to interact with one another in a manner defined by their interactive multi-user application. For example, slave process 706 can receive state-vector updates from different client members, change the state vector based on these updates, and distribute messages that inform each client member about the relevant state-vector updates caused by other client members. Slave process 706 can also time-stamp (i) each entry of the state vector with a time stamp indicating the last update time and (ii) each of the distributed messages with a time stamp indicating when the message was generated. As already indicated above, the state-vector updates and the time stamps enable the client members to achieve results that are consistent across the entire application group despite the fact that substantially all application-specific processing is carried out at different respective host terminals, which might process the application data substantially concurrently and in parallel to one another.

As used herein, the term “application-agnostic” designates a feature that is sufficiently generic in nature, function, and/or behavior so that this feature can be applied to or used in conjunction with different interactive multi-user applications. However, different application-agnostic tools and/or processes can be combined and configured to create a process that is application-specific. For example, each of slave processes 220₁ and 220₃ (FIG. 2) is created at server 110 by invoking, combining, and configuring a corresponding set of application-agnostic tools (see, e.g., Table 2). However, slave process 220₁ is specific to App A in the sense that it can be used to support App A and cannot be used to support App B (see Table 1). Similarly, slave process 220₃ is specific to App B in the sense that it can be used to support App B and cannot be used to support App A.

As used herein, the term “executable” of an application refers to an electronic file or a set of files that causes a processor or computer to perform application tasks according to encoded instructions. An operating system usually retains control over resources available to the processor or computer, requiring an executable to make system calls to access resources. Since each operating system generally has its own system-call architecture, each executable is tied to a specific operating system, which causes executables corresponding to the same interactive multi-user application but residing in different client terminals to possibly differ from one another. Despite these possible differences, the executables running on client terminals of each particular application group are mutually compatible with each other in the sense that each of them causes the respective client terminal to exhibit the same outward behavior in response to the same set of stimuli received from the user and/or peer client terminals.

As used herein, the term “global state” of an interactive multi-user application refers to a set of parameters from a parameter space shared by the application clients that fully characterizes the objects of the application invoked by the clients. The term “object” refers to a compilation of attributes (object elements) and behaviors (methods) encapsulating an entity and/or to an entity that can be manipulated by commands of a programming language.

As used herein, the term “uplink” designates communications directed from a client to the server. The term “downlink” designates communications directed from the server to a client.

While this invention has been described with reference to illustrative embodiments, this description is not intended to be construed in a limiting sense. For example, not all client terminals of an application group need to be mobile or even wireless terminals. One skilled in the art will appreciate that certain embodiments of the inventions can be used with stationary wireless or wired terminals. Various modifications of the described embodiments, as well as other embodiments of the invention, which are apparent to persons skilled in the art to which the invention pertains are deemed to lie within the principle and scope of the invention as expressed in the following claims.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium or loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Unless explicitly stated otherwise, each numerical value and range should be interpreted as being approximate as if the word “about” or “approximately” preceded the value of the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. At a terminal of a communication system, a method of running an executable of a first interactive multi-user application, comprising:
(A) sending, to a server of the communication system, a request to establish or join, as a client, a first application group corresponding to the first interactive multi-user application;
(B) providing, to the server, input to configure one or more application-agnostic tools implemented at the server to create or update at the server a slave process corresponding to the first application group; and
(C) running the executable to calculate a global state of the first interactive multi-user application based on communications with the slave process.

2. The invention of claim 1, wherein step (C) comprises:
(C1) sending to the slave process an uplink state-vector update corresponding to the client;
(C2) receiving from the slave process a downlink state-vector update; and
(C3) calculating the global state based on the uplink and downlink state-vector updates.

3. The invention of claim 2, wherein step (C1) comprises time-stamping the uplink state-vector update.

4. The invention of claim 2, wherein step (C3) comprises using time stamps of downlink state-vector updates corresponding to different clients of the first application group, a time stamp of the uplink state-vector update, and a set of pre-defined conflict-resolution rules to cause the calculated global state to be consistent with global states calculated in other clients of the first application group.

5. The invention of claim 2, wherein:
the state-vector updates of steps (C1) and (C2) comprise geo-location information corresponding to different clients of the first application group;
the method further comprises:
retrieving a map from a third-party server, the map having boundaries defined based on the geo-location information; and
marking geo-locations of the clients on the retrieved map.

6. The invention of claim 1, further comprising:
(D) starting an executable of a second interactive multi-user application;
(E) sending to the server a request to establish or join, as a client, a second application group corresponding to the second interactive multi-user application;
(F) providing, to the server, input to configure the one or more application-agnostic tools to create or update at the server a different second slave process corresponding to the second application group; and
(G) running the executable of the second application to calculate a global state of the second application based on communications with the second slave process.

7. The invention of claim 6, wherein:
the second application is a separate instance of the first application; and
a set of terminals hosting the clients from the first application group is different from a set of terminals hosting the clients from the second application group.

8. The invention of claim 6, wherein the second application is different from the first application.

9. The invention of claim 1, wherein step (B) comprises defining a macro for the slave process.

10. The invention of claim 9, wherein the macro operates on a state vector corresponding to the first application.

11. The invention of claim 1, further comprising configuring and storing an application feature at a third-party server, wherein step (C) comprises sending to the slave process a pointer link to the stored application feature for distribution within the first application group.

12. The invention of claim 11, wherein the application feature is an avatar.

13. The invention of claim 1, wherein step (C) comprises:
(C1) receiving from the first slave process a pointer link to an application feature configured by a different client of the first application group and stored at a third-party server;
(C2) retrieving said application feature from the third-party server; and
(C3) incorporating the retrieved feature into the first application.

14. The invention of claim 13, wherein the application feature is an avatar.

15. The invention of claim 1, wherein step (A) comprises communicating with a master process that controls the slave process at the server.

16. The invention of claim 1, wherein the terminal is a mobile terminal connected to the server via a wireless link.

17. The invention of claim 1, wherein:
the terminal comprises a geo-location sensor; and
step (C) comprises:
(C1) reading geo-location information from the sensor; and
(C2) providing said geo-location information to the slave process.

18. The invention of claim 1, wherein:
the terminal comprises a compass; and
step (C) comprises:
(C1) determining a pointing angle based on a compass reading; and
(C2) providing said pointing angle to the slave process.

19. A machine-readable medium, having encoded thereon program code, wherein, when the program code is executed by a machine, the machine implements the method of claim 1.

20. A terminal of a communication system, comprising:
means for sending, to a server of the communication system, a request to establish or join, as a client, a first application group corresponding to a first interactive multi-user application;
means for providing, to the server, input to configure one or more application-agnostic tools implemented at the server to create or update at the server a slave process corresponding to the first application group; and
means for running an executable of the first interactive multi-user application to calculate a global state of the first interactive multi-user application based on communications with the slave process.
